(19) United States
(12) Patent Application Publication
(10) Pub. No.: US 2004/0017327 A1
(43) Pub. Date: Jan. 29, 2004

(54) Dual polarized integrated antenna

(75) Inventor: Athanasios Petropoulos, Chicago, IL (US)

Correspondence Address: VEDDER PRICE KAUFMAN & KAMMHOLZ, 222 N. LASALLE STREET, CHICAGO, IL, 60601, US

(73) Assignee: Andrew Corporation, Addison, IL (US)

(21) Appl. No.: 10/064,563

(22) Filed: Jul. 26, 2002

(51) Int. Cl. H01Q 1/36; H01Q 21/00

(52) U.S. Cl. 343/895; 343/725

(57) ABSTRACT

A dual polarized integrated antenna comprising: a quadrifilar radiator; a printed circuit board having a ground plane on an upper surface, wherein the quadrifilar radiator is centrally disposed upon the ground plane; a plurality of lower surface micro-strip traces disposed on a lower surface of the printed circuit board; and a monopole array mounted on the printed circuit board and contactingly engaging the plurality of lower surface micro-strip traces.

### BACKGROUND OF INVENTION

The present invention relates to the field of antennas, more specifically to a dual polarized integrated antenna for hemispherical transmission via satellite and terrestrial bands.

The growth of wireless communications has produced an increasing demand for improved transmission of radio waves using known transmission techniques. One common type of antenna is a helical antenna including at least one conductor disposed in a helical shape, which typically radiates in an axial mode or in a normal mode. Maximum radiation is provided along the helix axis while operating in the axial mode. Preferably, the helix circumference is approximately on the order of one wavelength. Whereas, when the antenna operates in the normal mode, the antenna produces radiation broadside to helix axis when the diameter of the helix axis is small with respect to the wavelength.

One common example of a helical antenna is a quadrifilar antenna. This antenna usually includes four windings extending from a central cavity and is typically composed of a pair of bifilar helices, otherwise commonly referred to as volutes. This antenna uses two orthogonal fractional-turn bifilar helices that are excited in phase quadrature. Each of the bifilar helices are fed through a balance-unbalance (balun) and the helical shaped arms of the helices are typically wires or metal strips of a length equivalent to the resonant length wound upon a small diameter having a large pitch angle.

Typically, the helical antenna is fed with a coaxial feed line that is coupled to the balun. The volute produces a broad beam width with low backlobes and a good axial-ratio characteristic over a wide angular range when properly excited. For this helical antenna, a voltage standing wave ratio greater than two to one (2:1) is typically produced over a three to five percent (3-5%) bandwidth.

In order to achieve orthogonal signals, i.e. signals that are ninety degrees out of phase, hybrid circuitry must be used. One disadvantage is that this hybrid circuitry increases production costs and produces an antenna having a larger size. Furthermore, the hybrid circuitry increases the weight the antenna, which can be a further disadvantage in mobile or compact instruments.

Another recent development with antennas is the increased requirement for mobility. With the growth of mobile devices that utilize antennas, there is an increased demand for efficiently placing an antenna on a printed circuit board. Typically, antennas are too heavy to be properly attached to a printed circuit board. Another common drawback of a mobile antenna structure is a proper grounding effect as it may be difficult to provide an absolute ground for a mobile device.

Therefore, there exists a need for a quadrifilar antenna for use in mobile applications that overcomes grounding restrictions.

### SUMMARY OF INVENTION

One embodiment of the present invention provides a self-phasing dual polarized integrated antenna that includes a quadrifilar radiator and a printed circuit board having a ground plane on an upper surface of the printed circuit board. The quadrifilar radiator is centrally disposed on the ground plane of the printed circuit board. The printed circuit board has a plurality of lower surface micro-strip traces positioned on the lower surface of the printed circuit board. The integrated antenna further has a monopole array mounted on the printed circuit board.

The quadrifilar radiator within the dual polarized integrated antenna includes a cylindrical dielectric element having an outer surface with a plurality of interleaved radiator micro-strip traces disposed thereon The radiator further has a coaxial cable disposed within the interior of the cylindrical dielectric element and a balun that is disposed between the radiator coaxial cable and the radiator micro-strip traces.

In another embodiment, the quadrifilar radiator is a three-quarter turn circularly polarized quadrifilar radiator. Furthermore, the monopole array includes four vertically polarized monopole elements disposed on the printed circuit board in a square formation having the quadrifilar radiator centrally disposed therebetween. The vertically polarized monopole elements are operatively connected via the lower surface micro-strip traces. The antenna further includes a micro-strip coaxial cable coupled to the plurality of lower surface micro-strip traces and a radiator coaxial connector coupled to the radiator coaxial cable.

In yet another embodiment, the quadrifilar radiator includes a radiator coaxial cable that extends up through the printed circuit board, a balun positioned at a top portion of the radiator coaxial cable and a plurality of cross-v dipole antennas. The cross-v dipole antennas are coupled to the balun and extend from the top portion of the semi-rigid cable to the ground plane of the printed circuit board at a forty-five degree angle. In this embodiment, the monopole array includes four vertically polarized monopole elements coupled via the lower surface micro-strip traces and squarely positioned on the printed circuit board.

The antenna of this embodiment further includes a first connector operatively coupled to the radiator coaxial cable, a second cable connector coupled to the lower surface micro-strip traces of the monopole array and a micro-strip coaxial cable coupled to the lower surface micro-strip traces via the second connector.

### BRIEF DESCRIPTION OF DRAWINGS

FIG. 1 illustrates a side view of a dual polarized integrated antenna in accordance with one embodiment of the present invention.

FIG. 2 illustrates a top view of the dual polarized integrated antenna of FIG. 1.

FIG. 3 illustrates a cross-sectional view of the dual polarized integrated antenna of FIG. 1 along the cross section III-III of FIG. 2.

FIG. 4 illustrates a bottom view of the micro strip traces disposed on a lower side of a printed circuit board of the dual polarized integrated antenna of FIG. 1.

FIG. 5 illustrates a radiation pattern of the dual polarized integrated antenna of FIG. 1.

FIG. 6 illustrates a side view of a dual polarized integrated antenna in accordance with another embodiment of the present invention.

FIG. 7 illustrates a top view of the dual polarized integrated antenna of FIG. 6.

FIG. 8 illustrates a radiation pattern of the dual polarized integrated antenna of FIG. 6.

### DETAILED DESCRIPTION

FIG. 1 illustrates a dual polarized integrated antenna 100 that includes a printed circuit board 102. The printed circuit board 102 contains, among other things, a ground plane 103 on an upper surface 106 of the printed circuit board 102 and a plurality of lower surface micro-strip traces 107 disposed on a lower surface 108 of the printed circuit board 102.

The antenna 100 also includes a quadrifilar radiator 110 centrally disposed on the ground plane 103 of the printed circuit board. The antenna 100 further includes a plurality of monopoles 112 forming a monopole array. In the preferred embodiment, the monopole array is defined by four monopoles 112, wherein only two monopoles 112 of the monopole array are illustrated in FIG. 1. The monopoles 112 are mounted on the printed circuit board 102 and contactingly engage the plurality of lower surface micro-strip traces 107. Furthermore, each of the monopoles 112 of the monopole array is disposed equidistant from the quadrifilar radiator 110 and the monopoles 112 are coupled to one another via the lower surface micro-strip traces 107.

In the preferred embodiment, the quadrifilar radiator 110 includes a cylindrical dielectric element 114 that has an outer surface having a plurality of interleaved radiator micro strip traces 116 disposed thereon. The radiator micro-strip traces 116 are also commonly referred to as helical arms and form helical pairs encircling the dielectric element 114 of the quadrifilar radiator 110. In the preferred embodiment, the quadrifilar radiator 110 includes two helical pairs 118, 120. A total of four radiator micro-strip traces 116, each having varying lengths encircle the dielectric element 114. Varying the lengths of the helical pairs circularly polarizes the quadrifilar radiator 110.

The first helical pair 118 is orthogonally orientated to a second helical pair 120. The helical pairs 118, 120 are offset such that the orthogonal impedance, the phase between the pairs, is approximately ninety degrees, in order to provide the desired circular polarization. In the preferred embodiment, the first helical pair 118 has a length less than the length of the second helical pair 120.

The quadrifilar radiator 110 further includes a radiator coaxial cable 128 disposed within the interior of the cylindrical dielectric element 114. The radiator coaxial cable 128 is outlined in FIG. 1, illustrated through the dielectric element 114. The radiator coaxial cable extends upwardly to contact a balun 126, also illustrated through the dielectric element, disposed within the dielectric element 114. The balun 126 couples the radiator coaxial cable 128 with the micro-strip traces 116.

Preferably, the quadrifilar radiator 110 is a three-quarter turn circularly polarized quadrifilar radiator. As illustrated in FIG. 1, the micro-strip traces 116 extend spirally around approximately three quarters of the outer surface of the dielectric element 114. It will be recognized by one of ordinary skill in the art that the pitch of the radiator micro-strip traces 116 affects the backside radiation and reduces antenna gain. The axial length of the helical pair directly affects the radiator micro-strip trace pitch and thereby the antenna gain. In one embodiment of the present invention, the first helical pair 118 has an axial length of approximately sixty (60) millimeters (mm) and the second helical pair 120 has an axial length of approximately sixty-five (65) mm. Furthermore, within one embodiment of the present invention, due to the adjustment in axial length, the first helical pair 118 is spirally disposed approximately three quarters of a turnaround the outer surface of the dielectric element 114 and the second helical pair 120 is spirally disposed approximately five eighths of a turn around the dielectric element.

The antenna 100 further includes a lower surface coaxial cable 122 that couples the quadrifilar radiator 110 to the plurality of lower surface micro-strip traces. A radiator coaxial connector 124 is operatively coupled to the lower surface coaxial cable 122, such that a coaxial cable may be connected to the antenna 100.

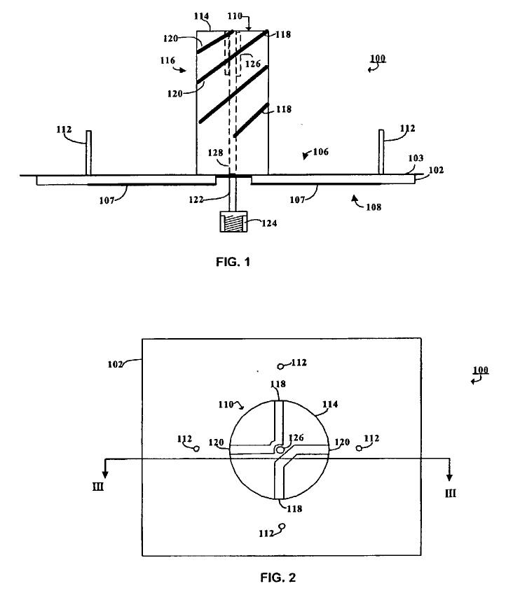

FIG. 2 illustrates a top view of the quadrifilar antenna 100 of one embodiment of the present invention. The balun 126 is disposed at the top of the dielectric element 114 to couple the radiator coaxial cable (not visible) to the helical pairs 118 and 120. As illustrated in FIG. 2, the radiator micro-strip traces are positioned across the top 114 of the dielectric element 110. FIG. 2 further illustrates the quadrifilar radiator 110 centrally disposed with respect to the monopole array, which includes the plurality of monopoles 112. In one embodiment of the present invention, the monopoles 112 of the monopole array are equally spaced a distance of approximately fifty (50) mm between adjacent monopoles.

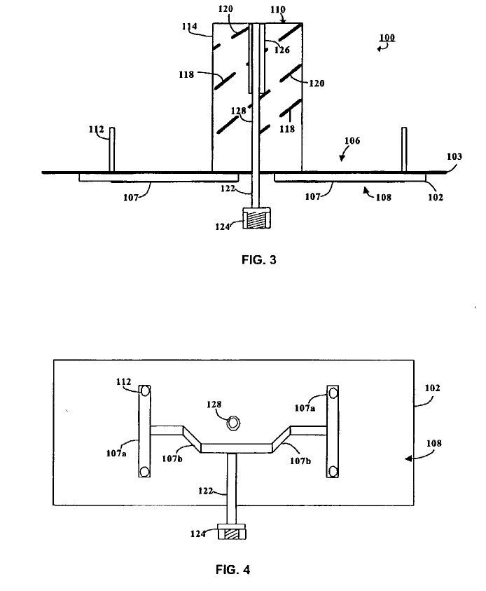

FIG. 3 illustrates a cross-sectional view of the dual polarized integrated antenna along the cross section III-III of FIG. 2. The radiator coaxial cable 128 is disposed within the dielectric element 114 and the balun 126 is also disposed at a distal end of the radiator coaxial cable 128. In one embodiment, the balun 126 is a split balun having a length of approximately twenty and seven-tenths (20.7) mm. In this embodiment, the first and second helical pairs, phantom illustrated at 118 and 120, have a diameter represented by the line 127, preferably a length of approximately fifteen and ninety-two hundredths (15.92) mm. Furthermore, in this embodiment, the ground plane 103 is a circular disc having a diameter of approximately two hundred and fifty (250) mm.

FIG. 4 illustrates the lower surface micro-strip traces 107 disposed on the lower surface of the printed circuit board 102. The lower surface micro-strip traces 107 are disposed substantially in an H-shape in order to interconnect the monopoles 112 of the monopole array at the distal end of the micro-strip traces 107. FIG. 4, further illustrates the radiator coaxial cable 128 disposed adjacent to the lower surface micro-strip traces 107. In one embodiment of the present invention, the lower surface micro-strip traces 107 have an impendence value of approximately fifty (50) ohms and the length of the lower surface coaxial cable 122 is approximately thirty-eight and five tenths (38.5) mm.

In another embodiment of the present invention, the micro-strip traces 107 have variable impedance values based on the location of the quadrifilar radiator relative to the monopoles 112 and the coaxial connector 124. As illustrated in FIG. 4, the micro-strip traces designated 107a have an impedance value of approximately seventy (70) ohms, the micro-strip traces designated 107b have an impedance value of approximately sixty-five (65) ohms, and the lower surface coaxial cable 122 has an impedance value of approximately fifty (50) ohms.

As discussed above with reference to FIG. 1, the lower surface micro-strip traces 107 are disposed on the lower surface 108 of the printed circuit board 102. The coaxial connector 124 is coupled to the lower surface micro-strip traces 107b via the coaxial cable 122 and micro-strip traces 107a across micro-strip traces 107b, which in one embodiment of the present invention the coaxial connector 124 is a rigid cable. It will be recognized by one skilled in the art that the coaxial cable 122 may also be a semi-rigid cable.

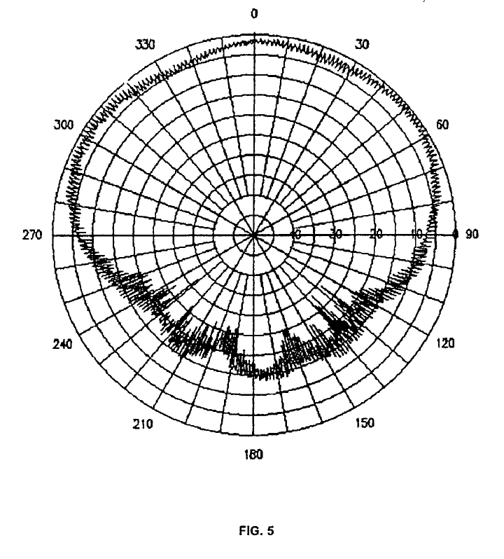

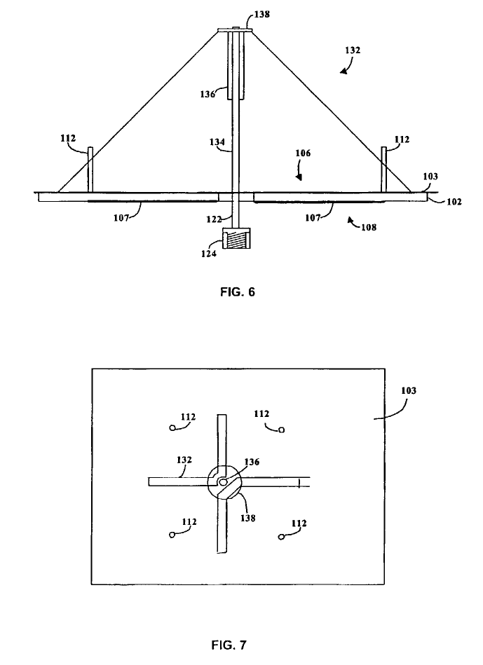

FIG. 5 illustrates a radiation pattern for the dual polarized integrated antenna of FIG. 1. The radiation pattern has an outer perimeter in degrees with an internal circular logarithmic designation in decibels and illustrates the radiation pattern for the three quarter turn quadrifilar radiator of one embodiment of the present invention. FIG. 5 illustrates the radiation pattern of one embodiment of the three-quarter turn quadrifilar radiator of the present invention at a frequency of 2.326 GHz.

FIG. 6 illustrates another embodiment of the dual polarized integrated antenna of the present invention. The antenna 132 includes the printed circuit board 102 having an upper surface 106 and a lower surface 108. The antenna 132 further includes a plurality of monopoles 112 that comprise the monopole array, a ground plane 103 and lower surface micro-strip traces 107. The coaxial cable 122 and the coaxial connector 124 are coupled to the lower surface micro-strip traces 107. In FIG. 6, only two of the four monopoles 112 are shown as a result of the alignment of the monopoles 112 in the monopole array.

The antenna 132 within the embodiment of FIG. 6 is a cross-v dipole antenna disposed at the distal end of a rigid cable 134 and a balun 136. The cross-v dipole antenna 132 extends from a top portion 138 to the ground plane 103 disposed on the top portion 106 of the printed circuit board 102. In one embodiment, the cross-v dipole antenna 132 engages the printed circuit board 102 at an angle of forty-five degrees. In this embodiment, the monopoles 112 are quarter wave monopoles.

Similar in function to the quadrifilar radiator 110 of FIG. 1, the cross-v dipole antenna is circularly polarized for transmission in the satellite band and the monopoles 112 are positioned for transmission in the terrestrial band.

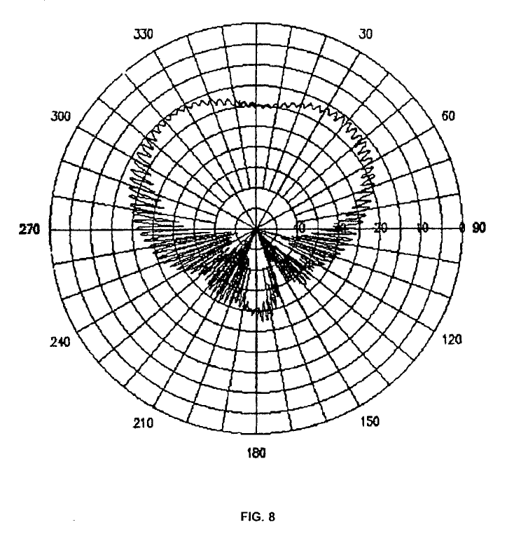

FIG. 7 illustrates a top view of the dual polarized integrated antenna of FIG. 6. The multiple cross-v dipoles 132 and monopoles 136 are shown. FIG. 7 further illustrates the orientation of the cross-v dipole 132 relative to the monopole array. FIG. 7 also shows the alignment of a top portion 138 of the cross-v dipole antenna wherein the balun 136 couples the cable 134, not visible in FIG. 7 due to the top portion 138, to the cross-v dipole antenna 132.

In the preferred embodiment, the cross-v dipole antenna elements have different lengths, as the length is determined by the height of the element. In one embodiment, two of the four dipole elements have a height of twelve (12) mm and two of the dipole elements have a height of nineteen (19) mm, wherein the height is defined as the distance between the top portion 138 and the printed circuit board. The difference in height or length of the dipole elements produces a phase difference of approximately ninety degrees, resulting in variance of amplitude of the radiation fields of more than six dB on the broadside. Moreover, a voltage standing wave ratio (VSWR) of the above embodiment is approximately 1.5.

In the above embodiment, the micro-strip traces 107 of FIG. 6, not visible in FIG. 7, are more specifically illustrated in FIG. 4. As with the embodiment of FIG. 1, the lower surface micro-strip traces 107 interconnect the monopoles 112 of the monopole array and couple the lower surface coaxial cable 122 to the monopole array. Via the coaxial connector 124, a coaxial feed may be provided to the monopole arrays through the micro-strip traces 107a and 107b of FIG. 4.

FIG. 8 illustrates a radiation pattern for the dual polarized integrated antenna of FIG. 6. The radiation pattern has an outer perimeter in degrees with an internal circular designation in decibels and illustrates the radiation pattern for the cross-v dipole antenna. FIG. 8 illustrates the radiation pattern of one embodiment at a frequency of 2.326 GHz.

It should be understood that the implementation of other variations and modifications of the invention in its various aspects may be readily apparent to those of ordinary skill in the art and that the invention is not limited by the specific embodiments described herein. It is therefore contemplated that the present disclosure is to cover any and all modifications, variations, or equivalents that fall within the spirit and scope of the basic underlying principles disclosed and claimed herein.

1. A dual polarized integrated antenna comprising:
a quadrifilar radiator;
a printed circuit board having a ground plane on an upper surface, wherein the quadrifilar radiator is centrally disposed upon the ground plane;
a plurality of lower surface micro-strip traces disposed on a lower surface of the printed circuit board; and
a monopole array mounted on the printed circuit board and contactingly engaging the plurality of lower surface micro-strip traces.

2. The dual polarized integrated antenna of claim 1 wherein the quadrifilar radiator comprises:
a cylindrical dielectric element having an outer surface with a plurality of interleaved radiator micro-strip traces disposed thereon;
a radiator coaxial cable interiorly disposed within the cylindrical dielectric element; and
a balun disposed between the radiator coaxial cable and the radiator micro-strip traces.

3. The dual polarized integrated antenna of claim 2 wherein the quadrifilar radiator is a three-quarter turn circularly polarized quadrifilar radiator.

4. The dual polarized integrated antenna of claim 1 wherein the monopole array comprises four vertically polarized monopole elements disposed on the printed circuit board, each vertically polarized monopole element disposed equidistant from the quadrifilar radiator.

5. The dual polarized integrated antenna of claim 4 wherein the vertically polarized monopole elements are operably connected via the lower surface micro-strip traces.

6. The antenna of claim 2 further comprising:
a lower surface coaxial cable operably coupled to the plurality of lower surface micro-strip traces; and
a radiator coaxial connector operably coupled to the radiator coaxial cable.

7. The dual polarized integrated antenna of claim 1 wherein the quadrifilar radiator comprises:
a radiator coaxial cable extending upward through the printed circuit board;
a balun disposed at a top portion of the radiator coaxial cable; and a plurality of cross-v dipole antennas operably coupled to the balun and extending from the top portion of the radiator coaxial cable to the ground plane of the printed circuit board.

8. The dual polarized integrated antenna of claim 7 wherein the plurality of cross-v dipole antennas are operably coupled to the ground plane at a forty-five degree angle.

9. The dual polarized integrated antenna of claim 8 wherein the monopole array comprises four vertically polarized monopole elements disposed on the printed circuit board, each vertically polarized monopole element disposed equidistant from the quadrifilar radiator.

10. The dual polarized integrated antenna of claim 9 further comprising:
a radiator coaxial connector operably coupled to the radiator coaxial cable;
a lower surface coaxial connector operably coupled to the lower surface micro-strip traces of the monopole array; and
a lower surface coaxial cable operably coupled to the lower surface micro-strip traces via the lower surface coaxial connector.

11. The dual polarized integrated antenna of claim 1 wherein the antenna is self-phasing.

12. A dual polarized integrated antenna comprising:
a quadrifilar radiator comprising:
a cylindrical dielectric element having an outer surface with a plurality of interleaved radiator micro-strip traces disposed thereon;
a radiator coaxial cable interiorly disposed within the cylindrical dielectrical element; and
a balun disposed between the radiator coaxial cable and the radiator micro-strip traces;
a printed circuit board having a ground plane on an upper surface, wherein the quadrifilar radiator is centrally disposed upon the ground plane;
a plurality of lower surface micro-strip traces disposed on a lower surface of the printed circuit board; and
a monopole array mounted on the printed circuit board and contactingly engaging the plurality of lower surface micro-strip traces.

13. The dual polarized integrated antenna of claim 12 wherein the quadrifilar radiator is a three-quarter turn circularly polarized quadrifilar radiator.

14. The dual polarized integrated antenna of claim 12 wherein the monopole array comprises four vertically polarized monopole elements disposed on the printed circuit board, each vertically polarized monopole element symmetrically disposed about the quadrifilar radiator.

15. The dual polarized integrated antenna of claim 14 further comprising:
a lower surface coaxial cable operably coupled to the plurality of lower surface micro-strip traces via a lower surface coaxial connector.

16. A dual polarized integrated antenna comprising:
a printed circuit board having a ground plane on an upper surface;
a quadrifilar radiator comprising:
a radiator coaxial cable;
a balun disposed at a top portion of the radiator coaxial cable; and
a plurality of cross-v dipole antennas operably coupled to the balun and extending from the top portion of the radiator coaxial cable to the ground plane of the printed circuit board;
a plurality of lower surface micro-strip traces disposed on a lower surface of the printed circuit board; and
a monopole array operably mounted on the printed circuit board and contactingly engaging the plurality of lower surface micro-strip traces.

17. The dual polarized integrated antenna of claim 16 wherein the plurality of cross-v dipole antennas are operably coupled to the ground plane at a forty-five degree angle.

18. The dual polarized integrated antenna of claim 16 wherein the monopole array comprises four vertically polarized monopole elements disposed on the printed circuit board, each vertically polarized monopole element disposed equidistant from the two nearest vertically polarized elements, defining an area configured as a square.

19. The dual polarized integrated antenna of claim 18 further comprising:
a radiator coaxial connector operably coupled to the radiator coaxial cable;
a lower surface coaxial connector operably coupled to the lower surface micro-strip traces of the monopole array; and
a lower surface coaxial cable operably coupled to the lower surface micro-strip traces via the lower surface coaxial connector.

20. A dual polarized integrated antenna comprising:
a three quarter turn circularly polarized quadrifilar radiator comprising:
a cylindrical dielectric element having an outer surface with a plurality of interleaved radiator micro-strip traces disposed thereon;
a radiator coaxial cable interiorly disposed within the cylindrical dielectrical element; and
a balun operably disposed between the radiator coaxial cable and the radiator micro-strip traces;
a printed circuit board having a ground plane on an upper surface, wherein the three-quarter turn circularly polarized quadrifilar radiator is centrally disposed upon the ground plane;
a plurality of lower surface micro-strip traces disposed on a lower surface of the printed circuit board;
a monopole array comprising four vertically polarized monopole elements operably coupled, via the lower surface micro-strip traces, to the printed circuit board, wherein each vertically polarized monopole element is disposed a desired distance from the quadrifilar radiator such that the vertically polarized monopole elements in combination define an area configured as a square; and
a lower surface coaxial cable operably coupled to the plurality of micro-strip traces via a lower surface coaxial connector.
